(19) United States
(12) Patent Application Publication
(10) Pub. No.: US 2026/0005257 A1
(43) Pub. Date: Jan. 1, 2026

(54) LITHIUM-SULFUR BATTERIES WITH PRELITHIATED CATHODES

(71) Applicant: Livent Lithium LLC, Philadelphia, PA (US)

(72) Inventors: Jian Xia, Belmont, NC (US); Marina Yakovleva, Gastonia, NC (US); Kenneth Brian Fitch, Cherryville, NC (US); Rebecca Black, Charlotte, NC (US)

(73) Assignee: Livent Lithium LLC, Philadelphia, PA (US)

(21) Appl. No.: 19/332,789

(22) Filed: Sep. 18, 2025

Related U.S. Application Data
(63) Continuation-in-part of application No. 19/091,303, filed on Mar. 26, 2025.
(60) Provisional application No. 63/570,314, filed on Mar. 27, 2024.
(60) Provisional application No. 63/705,617, filed on Oct. 10, 2024.

(51) Int. Cl. H01M 4/62; H01M 4/02; H01M 4/136; H01M 4/58; H01M 10/052

(52) U.S. Cl. CPC H01M 4/628; H01M 4/136; H01M 4/5815; H01M 10/052; H01M 2004/028

(57) ABSTRACT

The present invention provides a battery including an anode, a sulfur or composite sulfur material cathode, a separator and/or an electrolyte, and a modulation layer. The sulfur or composite sulfur cathode may be partially or fully prelithiated with a lithium composition comprised of lithium metal powder, a polymer binder compatible with the lithium metal powder and a rheology modifier compatible with the lithium metal powder. A modulation layer may be positioned between the prelithiation layer and the cathode. The modulation layer may be derived from a polymer material or may be a ceramic compound comprising a ceramic and a polymer.

### RELATED APPLICATION

This application is a continuation-in-part and claims priority to U.S. patent application Ser. No. 19/091,303 filed on Mar. 26, 2025 which claims priority to U.S. Provisional Application 63/570,314 filed on Mar. 27, 2024, and U.S. Provisional Application No. 63/705,617 filed on Oct. 10, 2024, the disclosures of which are incorporated by reference herein in their entireties.

### FIELD

The present invention relates to lithium-sulfur batteries.

### BACKGROUND

Lithium-sulfur batteries and secondary or rechargeable batteries are alternatives to conventional lithium-ion batteries. Typically, lithium-ion batteries have been used in various portable devices such as cellphones due to their having a high energy density resulting in longer lifespans while avoiding rapid discharge which may cause overheating, rupture, explosion due to the inherent reactivity of lithium metal. It is preferred in these applications that the batteries have the highest specific capacity possible but still provide safe operating conditions and good cyclability so that the high specific capacity is maintained in subsequent recharging and discharging cycles.

Lithium-sulfur batteries have found use in certain applications such as in larger power applications. Lithium-sulfur batteries may have higher capacity and may be lightweight. The energy density of a lithium-sulfur is theoretically high; namely the lithium of the anode has an energy density of 3,830 mAh/g and sulfur of the cathode has an energy density of 1,675 mAh/g. Thus, lithium-sulfur batteries potentially may offer a high energy density.

A conventional lithium-sulfur battery uses sulfur or a composite sulfur or Li₂S as cathode and a lithium metal, silicon compounds or carbon-based anode. This in contrast to conventional lithium-ion batteries which utilize, for example, LiCoO₂ or LiNiO₂ as the cathode material. There, however, is a heightened concern about cobalt and nickel being so-called critical minerals, and their toxicity. The replacement thereof with more environmentally-friendly and readily available compounds such as sulfur would be desirable.

The cathode may be formed from elemental sulfur or a composite sulfur material that is electroactive. The sulfur or composite sulfur material may be mixed with an electrochemically conductive material such as carbon, applied to a current collector, for example copper or nickel foil, and calendered. An electrolyte may be applied and a separator placed between the cathode and the anode. In conventional lithium sulfur batteries, the cathode is then lithiated in-situ by discharging lithium from the anode. The anode may be lithium metal, lithium metal alloy, or fully prelithiated silicon or silicon materials or carbonaceous materials.

In a lithium-sulfur battery, electric energy may be generated by an oxidation/reduction reaction of lithium and sulfur as follows:

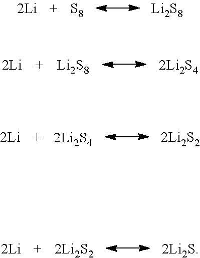

Lithium-sulfur batteries have, however, faced technical challenges that preclude meaningful commercialization. For example, the poor electrochemical conductivity of elemental sulfur and the polysulfide shuttle effect caused by the dissolution of intermediate lithium polysulfide species in the electrolyte leads to the undesirable loss of sulfur resulting in capacity fading. Additionally, when used with lithium metal anodes, the problems associated with dendritic deposition and electrolyte consumption are exacerbated by degrative reactions with the polysulfides.

### SUMMARY OF THE INVENTION

To overcome these challenges, the present invention provides for the full or partial prelithiation of the cathode using a printable lithium composition. Full prelithiation may allow for the battery to be anode-free or for the use of non-lithium providing anodes. Prelithiation of the cathode may also permit the use of a thinner lithium metal anode.

The present invention provides a battery including an anode, a cathode, a separator, an electrolyte and a modulation composition. The anode may be lithium metal or a partially of fully prelithiated anode and a sulfur or composite sulfur cathode. The sulfur or composite sulfur cathode may be partially or fully prelithiated with a lithium composition comprised of lithium metal powder, a polymer binder compatible with the lithium metal powder and a rheology modifier compatible with the lithium metal powder and a modulation layer between the printable lithium composition and the cathode. In one embodiment, the modulation layer may be a polymeric coating. In another embodiment, the modulation layer may be a ceramic compound comprising a ceramic and a polymer, inorganic salts or a composite material. In one embodiment, the modulation layer may be an artificial solid electrolyte interface material (“SEI”). In another embodiment, the modulation layer may be a ceramic compound including a ceramic and a polymer. By reducing or slowing down (modulation) the reaction between lithium and sulfur species, the rate and level of heat generated may be lowered. Moreover, the negative effects of polysulfide shuttling and rapid diffusion of lithium may be obviated.

The present invention in another embodiment provides a solid-state battery comprising a lithium or silicon anode, a solid, semi-solid or hybrid electrolyte and a sulfur or composite sulfur cathode. The sulfur or composite sulfur material cathode after addition of a modulation layer may be prelithiated with a printable lithium composition comprised of lithium metal powder, a polymer binder compatible with the lithium metal powder, and a rheology modifier compatible with the lithium metal powder.

The present invention in yet another embodiment provides an anode-free battery including a solid, semi-solid or liquid electrolyte and a sulfur or composite sulfur material cathode. The sulfur cathode after addition of a modulation layer may be prelithiated with a printable lithium composition comprised of lithium metal powder, a polymer binder compatible with the lithium metal powder, and a rheology modifier compatible with the lithium metal powder. An anode may be formed by extracting lithium ions from the prelithiated cathode during a first charge and depositing on a bare current collector. The bare current collector may have a seed layer of the printable lithium composition to maintain a lithium reservoir.

### DESCRIPTION OF THE DRAWING

FIG. 1 is a voltage versus capacity curve for a sulfur cathode and a lithium metal foil anode corresponding to Control A of the Examples.

FIG. 2 is a voltage versus capacity curve for a prelithiated sulfur cathode and a lithium metal foil anode corresponding to Control B of the Examples.

FIG. 3 is a plot showing the cycling performance for a coin cell formed from a conventional sulfur cathode and a prelithiated sulfur cathode with a printable lithium based anode or a conventional lithium foil anode compared to a prelithiated sulfur cathode that includes a polymer modulation layer and a lithium foil anode corresponding to Example 1 of the Examples.

FIG. 4 is a voltage versus capacity curve for a sulfur cathode, a ceramic compound modulation layer and a lithium metal foil anode corresponding to Example 2 of the Examples.

FIG. 5 is a voltage versus capacity curve for a prelithiated sulfur cathode having a ceramic compound modulation layer and a lithium metal foil anode corresponding to Example 3.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20 percent, 10 percent, 5 percent, 1 percent, 0.5 percent, or even 0.1 percent of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20 percent or more.

All patents, patent applications and publications referred to herein are incorporated by reference in their entirety. In case of a conflict in terminology, the present specification is controlling.

In accordance with the present invention provides a battery including an anode, a sulfur or composite sulfur material cathode, and electrolyte, a separator and a modulation composition. The anode may be formed from lithium, silicon or carbonaceous materials.

The sulfur or composite sulfur cathode may be prelithiated with a printable lithium composition including lithium metal powder, a polymer binder compatible with the lithium metal powder, and a rheology modifier compatible with the lithium metal powder and the polymer binder. Exemplary cathode materials may include elemental sulfur, sulfur series compounds such as sulfur carbonaceous composites (e.g., graphene), and mixtures thereof. The cathode material may further include a conductor and a binder for increasing binding strength between the sulfur-based cathode material and the current collector. In one embodiment, the conductor may be carbon-based (e.g., carbon black or graphene). In another embodiment, the conductor may be a conductive polymer (e.g., polyaniline, polythiophene, polyacetylene, or polypyrene). The cathode binder may be compatible with lithium metal powder and non-polar solvents and should not dissolve in the non-polar solvent. Exemplary cathode binders may include polyaniline, poly(vinyl acetate), polyvinyl alcohol, polyethylene oxide, polyisobutylene, (preferably high molecular weight polyisobutylene), butyl rubbers, polyvinyl pyrrolidone, alkylated polyethylene oxide, crosslinked polyethylene oxide, polyvinyl ether, poly(methyl methacrylate), polyvinylidene fluoride, poly(ethyl acrylate), polytetrafluoroethylene, polyvinyl chloride, polyacrylonitrile, polyvinylpyridine, polyvinylidene fluoride-co-hexafluoropropylene, polystyrene, cross-linked quaternary ammonium cationic starch, polysaccharides, xanthan gum, and derivatives, blends and copolymers thereof, and the like, may be used.

The cathode may be formed using conventional methods such as mixing the sulfur-active cathode material, the conductor and the binder in an organic solvent which is applied on the current collector such as in U.S. Pat. No. 10,468,650 B2, the disclosure of which is incorporated herein by reference in its entirety. Exemplary cathode current collectors may include foamed aluminum, aluminum foil, foamed nickel, nickel foil, titanium foil, a carbon-based material, (e.g., carbon coated nickel and carbon coated aluminum), stainless steel foil, titanium foil and composite current collectors.

In another embodiment, the cathode may comprise a sulfur active material and three-dimension graphene such as described, for example, in U.S. Pat. Nos. 11,133,495 B2 and 11,462,728 B2, the disclosures of which are incorporated herein by reference in their entireties.

Prior to prelithiation, a modulation layer may be applied to the cathode. In one embodiment, a lithium modulation layer may be provided between the prelithiation layer and the sulfur or composite sulfur cathode.

During the early lithiation stages of sulfur long chain polysulfides are formed. These long chain polysulfide species are extremely soluble in ether-based solvents and can diffuse away from the cathode. One can determine the effectiveness of a modulation layer to confine polysulfides to the cathode by measuring the capacity of the two stages of sulfur lithiation in a given sulfur cathode active material. The first stage of lithiation occurs between about 2.3V and 2.1V where long chain soluble polysulfides are formed. The capacity of this stage should be constant regardless of polysulfide diffusion. However, if these polysulfides diffuse away from the cathode they are not available for further lithiation to short chain polysulfides and eventually Li₂S. The result is an overall reduction of discharge capacity and specifically a reduction of capacity in the second stage of lithiation that occurs at 2.1V-1.7V.

The modulation layer may serve two functions, namely mitigating the polysulfide shuttle effect and slowing the unwanted rapid diffusion of lithium into the sulfur or composite sulfur cathode. With respect to the polysulfide shuttle effect, the lithium modulation layer may reduce the adverse effects such as capacity fade and self-discharge caused during charging when Li₂S is oxidized back to S₈ through an intermediate polysulfide anions Sₓ. Since the Sₓ polysulfides generated at the cathode are soluble in the electrolyte, the Sₓ polysulfides may migrate or shuttle to the anode. At the lithium anode, the Sₓ polysulfides react with the lithium in a parasitic fashion to generate lower-order polysulfides, which shuttle back to the cathode and regenerate the higher forms of polysulfide.

With respect to reducing unwanted rapid lithium diffusion, controlling the diffusion may reduce thermal spikes caused by the reaction of lithium and sulfur, and may enhance structural stability of the cathode. The modulation may be lithium-ion permeable barrier allowing lithium ions to pass through while regulating their flux and the rate thereof into the sulfur cathode. The modulation layer may essentially be a protective barrier in which lithiation is enabled while the direct contact between lithium metal and sulfur may be limited.

The lithium modulation layer may be a polymeric coating on the sulfur or composite sulfur material cathode and may be selected from the group consisting of polyaniline, poly(vinyl acetate), polyvinyl alcohol, polyethylene oxide, polyisobutylene, (preferably high molecular weight polyisobutylene), butyl rubbers, polyvinyl pyrrolidone, styrene butadiene rubber, alkylated polyethylene oxide, crosslinked polyethylene oxide, polyvinyl ether, poly(methyl methacrylate), polyvinylidene fluoride, poly(ethyl acrylate), polytetrafluoroethylene, silicon-based polymers, polyvinyl chloride, polyacrylonitrile, polyvinylpyridine, polyvinylidene fluoride-co-hexafluoropropylene, polystyrene, cross-linked quaternary ammonium cationic starch, polysaccharides, xanthan gum, and derivatives, blends and copolymers thereof, and the like, may be used. The polymer coating may further include carbonaceous materials such as carbon-nanotube, carbon black, graphene particularly with nanopores, graphite, carbon fiber, electrolyte salts, LiF, metallic particles (such as Ag nano particles), solid electrolytes including sulfites and oxides, and polymer electrolytes. For example, carbon black in the polymer matrix may in effect trap polysulfides via physical adsorption and redox mediation. The thickness of the coating may be 5 micron to 20 micron. The polymer matrix may provide physical confinement and chemical anchoring of the polysulfide species.

In another embodiment, the lithium modulation layer may be a ceramic layer comprising a ceramic and a polymer. The ceramic layer may have a thickness of 5 micron to 20 micron. Exemplary ceramics may include one or more of Al₂O₃, ZrO₂, SiO₂, TiO₂, ZnO, BaTiO₃, SrTiO₃, CaCO₃, CaO, CeO₂, NiO, MgO, SnO₂, Y₂O₃, Pb (ZrTi)O₃, and (ZrTi)O₃. In another exemplary embodiment, ceramic may include BaTiO₃ and Al₂O₃ such as described in U.S. Patent Publication No. US 2025/0112243A1 to Kim et al., the disclosure of which is incorporated herein by reference in its entirety. Suitable exemplary polymers may include polyaniline, poly(vinyl acetate), polyvinyl alcohol, polyethylene oxide, polyisobutylene, (preferably high molecular weight polyisobutylene), butyl rubbers, polyvinyl pyrrolidone, alkylated polyethylene oxide, crosslinked polyethylene oxide, polyvinyl ether, poly(methyl methacrylate), polyvinylidene fluoride, poly(ethyl acrylate), polytetrafluoroethylene, polyvinyl chloride, polyacrylonitrile, polyvinylpyridine, polyvinylidene fluoride-co-hexafluoropropylene, polystyrene, and derivatives, blends and copolymers thereof, and the like, may be used. For example, TiO₂ in the form of nanoparticles embedded in a polymer matrix forms a nanostructured barrier that restricts the migration of larger polysulfide molecules while allowing lithium ions to permeate. The tortuous pathways and pore size distribution acts as a size-selective filter to regulate the flux of lithium ions and to confine polysulfides within the cathode region. Chemically, TiO₂ exhibits strong affinity for polysulfides through Lewis acid-base interactions. These interactions anchor polysulfide species to the TiO₂ surface, preventing their migration to the anode and reducing parasitic reactions.

The printable lithium composition may be applied to the cathode and may include a lithium metal powder, a polymer binder compatible with the lithium metal powder, and a rheology modifier compatible with the lithium metal powder and the rheology modifier, such as described in U.S. Pat. Nos. 11,735,764 B2 and 12,095,029 B2. An exemplary printable lithium composition is Liovix® available from Rio Tinto Lithium PLC. A solvent may be included in the printable lithium composition, wherein the solvent is compatible with the lithium powder and compatible with (e.g., able to form suspension or dissolve in) the polymer binder. The solvent may be included as a component during the initial preparation of the printable lithium composition, or added later after the printable lithium composition is prepared. Preferably, the solvent is non-polar.

The lithium metal powder of the printable lithium composition may be in the form of a finely divided powder. The lithium metal powder typically has a mean particle size of less than about 80 microns, often less than about 20 microns and sometimes less than about 10 microns (e.g., about 5 microns). The lithium metal powder may be a low pyrophoricity stabilized lithium metal power (SLMP®) available from Rio Tinto Lithium PLC. The lithium metal powder may also include a substantially continuous layer or coating of fluorine, wax, phosphorus, a polymer, or the combination thereof (as disclosed in, for example, U.S. Pat. Nos. 5,567,474, 5,776,369, and 5,976,403). Lithium metal powder has a significantly reduced reaction with moisture and air. The lithium metal powder may be dry-mixed with a sulfur-based powder and formed into a paste, to form a dry cathode.

The lithium metal powder may also be made from the alloyed lithium with a metal. For example, the lithium metal powder may be alloyed with a Group I-VIII element. Suitable elements from Group IB may include, for example, silver, or gold. Suitable elements from Group IIB may include, for example, zinc, cadmium, or mercury. Suitable elements from Group IIA of the Periodic Table may include beryllium, magnesium, calcium, strontium, barium, and radium. Elements from Group IIIA that may be used in the present invention may include, for example, boron, aluminum, gallium, indium, or thallium. Elements from Group IVA that may be used in the present invention may include, for example, carbon, silicon, germanium, tin, or lead. Elements from Group VA that may be used in the present invention may include, for example, nitrogen, phosphorus, or bismuth. Suitable elements from Group VIIIB may include, for example, palladium, or platinum.

The polymer binder of the printable lithium formulation is selected so as to be compatible with the lithium metal powder. “Compatible with” or “compatibility” is intended to convey that the polymer binder does not violently react with the lithium metal powder resulting in a safety hazard. The lithium metal powder and the polymer binder for the printable lithium formulation may react to form a lithium-polymer complex, however, such complex should be stable at various temperatures. It is recognized that the amount (concentration) of lithium and polymer binder contribute to the stability and reactivity. The polymer binder may have a molecular weight of about 1,000 to about 8,000,000, and often has a molecular weight of 2,000,000 to 5,000,000. Suitable polymer binders may include one or more of poly(ethylene oxide), polystyrene, polyisobutylene, natural rubbers, butadiene rubbers, styrene-butadiene rubber, polyisoprene rubbers, butyl rubbers, hydrogenated nitrile butadiene rubbers, epichlorohydrin rubbers, acrylate rubbers, silicon rubbers, nitrile rubbers, polyacrylic acid, polyvinylidene chloride, polyvinyl acetate, ethylene propylene diene termonomer, ethylene vinyl acetate copolymer, ethylene-propylene copolymers, ethylene-propylene terpolymers, polybutenes. The binder of the printable lithium formulation may also be a wax.

The rheology modifier is selected so as to be compatible with the lithium metal powder and the polymer binder and dispersible in the composition. A preferred embodiment of the printable lithium composition includes a carbon-based rheology modifier such as carbon nanotubes. Other compatible carbon-based rheology modifiers include carbon black, fibrillized carbon black, graphene, graphite, hard carbon and mixtures or blends thereof.

Additional rheology modifiers may be added to the composition to modify properties such as viscosity and flow under shear conditions. The rheology modifier may also provide conductivity, improved capacity and/or improved stability/safety depending on the selection of the rheology modifier. To this end, the rheology modifier may be the combination of two or more compounds so as to provide different properties or to provide additive properties. Exemplary additional rheology modifiers may include one or more of silicon nanotubes, fumed silica, titanium dioxide, zirconium dioxide and other Group IIA, IIIA, IVB, VB and VIA elements/compounds and mixtures or blends thereof. Other additives intended to increase lithium ion conductivity can be used; for example, electrochemical device electrolyte salts such as lithium perchlorate (LiClO₄), lithium hexafluorophosphate (LiPF₆), lithium difluoro(oxalate)borate (LiDFOB), lithium tetrafluoroborate (LiBF₄), lithium nitrate (LiNO₃), lithium bis(oxalate) borate (LiBOB), lithium trifluoromethanesulfonimide (LiTFSI), lithium bis(fluorosulfonyl) imide (LiFSI).

Non-polar solvents compatible with lithium metal powder may include acyclic hydrocarbons, cyclic hydrocarbons, aromatic hydrocarbons, symmetrical ethers, unsymmetrical ethers, cyclic ethers, alkanes, sulfones, mineral oil, and mixtures, blends or cosolvents thereof. Examples of suitable acyclic and cyclic hydrocarbons include n-hexane, n-heptane, cyclohexane, and the like. Examples of suitable aromatic hydrocarbons include toluene, ethylbenzene, xylene, isopropylbenzene (cumene), and the like. Examples of suitable symmetrical, unsymmetrical and cyclic ethers include di-n-butyl ether, methyl t-butyl ether, tetrahydrofuran, glymes and the like. Commercially available isoparaffinic synthetic hydrocarbon solvents with tailored boiling point ranges such as Shell Sol® (Shell Chemicals) or Isopar® (Exxon) are also suitable.

The polymer binder of the printable lithium formulation and solvents are selected to be compatible with each other and with the lithium metal powder. In general, the binder or solvent should be non-reactive with the lithium metal powder or in amounts so that any reaction is kept to a minimum and violent reactions are avoided. The binder and solvent should be compatible with each other at the temperatures at which the printable lithium composition is made and will be used. Preferably the solvent (or co-solvent) will have sufficient volatility to readily evaporate from the printable lithium composition (e.g., in slurry form) to provide drying of the printable lithium composition (slurry) after application.

The components of the printable lithium composition may be mixed together as a slurry or paste to have a high concentration of solids. Optionally, a sulfur-based compound may be mixed with the printable lithium composition and formed into a slurry or paste. Thus the slurry/paste may be in the form of a concentrate with not all of the solvent necessarily added prior to the time of depositing or applying to the substrate. In one embodiment, the lithium metal powder may be uniformly suspended in the solvent so that when applied or deposited a substantially uniform distribution of lithium metal powder is deposited or applied. Dry lithium powder may be dispersed such as by agitating or stirring vigorously to apply high sheer forces.

Conventional pre-lithiation surface treatments require compositions having very low binder content and very high lithium content. However, embodiments of the printable lithium composition in accordance with the present invention may accommodate higher binder ratios, including up to 20 percent on dry basis, as an advantage of using a printable lithium composition. Conventional lithium compositions could not accommodate higher binder ratios as the resulting composition blocked the pores of an applicator and created resistance when applying the composition. Various properties of the printable lithium composition, such as viscosity and flow, may be modified by increasing the binder and modifier content up to 50 percent dry basis without meaningful loss of electrochemical activity of lithium. The binder content facilitates the loading of the printable lithium composition and the composition flow during printing. The printable lithium composition may comprise between about 50 percent to about 98 percent by weight of lithium metal powder and about 2 percent to about 50 percent by weight of polymer binder and rheology modifiers on a dry weight basis. In one embodiment, the printable lithium composition comprises between about 60 percent to about 90 percent by weight lithium metal powder and between about 10 percent to about 40 percent by weight of polymer binder and rheology modifiers. In another embodiment the printable lithium composition comprises between about 75 percent to about 85 percent by weight of lithium metal powder and between about 15 percent to about 30 percent by weight of polymer binder and rheology modifiers.

In one embodiment, the printable lithium composition comprises on a solution basis about 5 to 50 percent lithium metal powder, about 0.1 to 20 percent polymer binder, about 0.1 to 30 percent rheology modifier and about 50 to 95 percent solvent. In one embodiment, the printable lithium composition comprises on a solution basis about 10 to 25 percent lithium metal powder, about 0.3 to 3 percent polymer binder having a molecular weight of about 3,000,000, about 0.5 to 3 percent rheology modifier, and about 75 to 85 percent solvent. The lithium composition may also be applied as a dry composition having less than 5 percent solvent and even less than 1 percent solvent. Typically, the printable lithium composition is applied or deposited to a thickness of about 10 microns to 200 microns prior to pressing and may include printing the lithium composition on a film such as a transfer film (e.g., PET). After pressing, the laminated thickness can be reduced to less than 50 microns, and often 1 to 20 microns.

In one embodiment, a lithium sulfur battery may be provided and includes the anode, the prelithiated sulfur or sulfur-composite cathode and an electrolyte of the present invention. The electrolyte may be a liquid electrolyte or a solid electrolyte.

If a liquid electrolyte is used, then the battery may include a separator such as porous glass, polymer, ceramic, or the like. Exemplary liquid electrolytes may include a non-aqueous solvent and an electrolyte salt. Examples of the solvent include, but are not limited to, ethylene carbonate, propylene carbonate, dioxolane, Bis(2,2,2-trifluoroethyl) ether, sulfolane, xylene, diglyme, tetrahydrofuran, tetraglyme, sulfone, dimethyl sulfone, dialkyl carbonate such as dimethyl carbonate, butyrolactone, N-methyl pyrrolidone, tetramethyl urea, glyme, crown ether, dimethoxy ethane, N,N-diethyl formamide, N,N-diethyl acetamide, hexamethyl phosphoamide, pyridine, dimethyl sulfoxide, N,N-dimethyl acetamide, tributyle phosphate, trimethyl phosphate, N,N,N,N-tetraethyl sulfamide, tetramethylene diamine, tetramethyl propylene diamine, pentamethylene triamine, methanol ethylene glycol, polyethylene glycol, nitromethane, trifluoro acetic acid, trifluoro methane sulfonic acid, sulfur dioxide, boron trifluoride, and the like, and a mixture thereof. Examples of the electrolyte salts include lithium bis(trifluoromethanesulfonyl)imide (LiTFSI), lithium trifluoromethanesulfonate (lithium triflate), lithium perchlorate (LiClO₄), lithium hexafluorophosphate (LiPF₆), lithium tetrafluoroborate (LiBF₄), lithium difluoro(oxalato)borate (LiDFOB), lithium bis(fluorosulfonyl)imide (LiFSI), and lithium nitrate (LiNO₃) and the like. A modulation composition, e.g., inorganic salts, may be added to the liquid electrolyte.

A solid-state battery may be provided in which the battery may include an anode, a prelithiated cathode of the present invention and a solid or semi-solid/quasi-solid/hybrid-solid electrolyte. The solid electrolyte may be an inorganic solid electrolyte or a solid polymer electrolyte. In one embodiment, the hybrid solid electrolyte (HSE) may have a NASICON-type crystal structure and may have either a rhombohedral or monoclinic structure. Lithium provides advantages over sodium in that lithium has the lowest standard reduction potential (−3.07 v) which results in a high cell nominal voltage. Additionally, lithium-based anodes and cathodes will form more stable and reversible batteries as compared to sodium-based compounds.

Specifically, the lithium-based solid electrolyte may comprise Li₃₊ₓ Aₓ B₂₋ₓ Si₂ PO_{12-d} C_{d} wherein A is a trivalent metal, B is a transition metal, C is a halogen or sulfur, x is 0.01 to 0.5, and d is 0 to 12. The trivalent metal may be selected from the group consisting of Sc, Y, La, Cr, Al, Fe, V, Cr, In, Ga, and Lu. The transition metal may be selected from the group consisting of Ti, Ge, Ta, Zr, Sn, Fe, V. Hf, Nb, Sb and As. Exemplary halogens may include chlorine, fluorine, bromine, and iodine when d is greater than 0, and d may be 0.05 to 0.1.

Specific lithium-based solid electrolyte materials are described in U.S. application Ser. No. 18/205,764 filed on Jun. 5, 2023 and may include Li_{3.4}Zr_{1.6}Sc_{0.4}Si₂PO₁₂, Li_{3.25}Zr_{1.75}Sc_{0.25}Si₂PO₁₂, Li_{3.4}Zr_{1.6}Sc_{0.4}Si₂PO_{11.95}Cl_{0.05}, Li_{3.4}Zr_{1.6}SC_{0.4}Si₂PO_{11.9}Cl_{0.1}, Li_{3.25}Zr_{1.75}Sc_{0.25}Si₂PO_{11.95}Cl_{0.05}, and Li_{3.25}Zr_{1.75}SC_{0.25}Si₂PO_{11.9}Cl_{0.1} and Li_{3.1}Zr_{1.9}Sc_{0.1}SiPO₁₂.

In another embodiment, the solid electrolyte may include the tantalum-doped lithium lanthanum zirconate (LLTZO), Li₁₊ₓAlₓTi₂₋ₓ(PO₄)₃ (LATP), and Li₁₊ₓAlGe₂₋ₓ(PO₄)₃ (LAGP), described, for example, in “Recent Developments and Challenges in Hybrid Solid Electrolytes for Lithium Ion Batteries” Han et al, Frontiers in Energy Research. September 2020, Vol. 5, pp 1-19, and in U.S. Publication No. 2020/0185758, the disclosure of which are incorporated herein by reference in their entireties.

In one embodiment, the solid electrolyte may be a hybrid solid electrolyte and include one of the above lithium-based solid electrolyte materials, a polymer solid electrolyte and an inorganic salt. The solid electrolyte may provide a modulation effect. In another embodiment, a modulation composition may be added/applied to the solid electrolyte. Exemplary polymer solid electrolytes may include polyethylene oxide (PEO), polysiloxane (PSO), polypropylene carbonate (PPC), polyethylene carbonate (PEC), polyvinyl chloride (PVC), polyacrylonitrile (PAN), polyacrylic acid (PAA), polyvinylidene fluoride or polyvinylidene difluoride (PVDF), poly(vinylidene fluoride-co-hexafluoropropylene) (PVDF-HFP), polymethyl methacrylate (PMMA), n-hydroxysuccinimide (NHD), polypropylene glycol (PPG), polydimethylsiloxane (PDMS), polypropylene carbonate (PPC), polycaprolactone (PCL), polytrimethylene carbonate (PTMC) and polyethylenimine (PEI) or a polymeric ionic liquid (PIL). Exemplary inorganic salts may include lithium bis(trifluoromethanesulfonyl)imide (LiTFSI), lithium bis(fluorosulfonyl)imide (LiFSI), lithium hexafluorophosphate (LiPF₆), lithium perchlorate (LiCLO₄), lithium tetrafluoroborate (LiBF₄), lithium sulfate (Li₂SO₄), trifluoromethyl radical (CF₃), lithium hexafluoroarsenate (LiAsF₆), lithium bis(oxalate)borate (LiBOB) and lithium difluoro(oxalate)borate (LiDFOB).

In another embodiment, in place of PEO, other polymeric ionic liquids (e.g., poly(ethylene glycol) diacrylate based ionic liquids) or ionic liquids having a high melting point may be used and include ionic liquids such as butylmethylimidazolium (BMIM), ethylmethylimidazolium (ENIM) and dimethylimidazolium (DMIM) units or similar.

In yet another embodiment, the LLZTO portion of the HSE may also be doped or replaced with an anion (oxygen) site doped garnet or Nasicon (sodium super ionic conductor) type solid electrolytes. Here the doping elements could be chlorine, fluorine, or sulfur to improve the grain boundary conductivity and decrease the interfacial resistance thereby improving cell performance.

In another embodiment, the polymers used as the lithium modulation layer or the solid electrolyte polymers may instead of being present as a layer may be dissolved in the liquid electrolyte. The polymers may, in addition to its acting as the modulation composition, may provide improved viscosity properties.

The lithium modulation layer may be a ceramic compound comprising a ceramic and a polymer. Exemplary ceramics may include one or more of Al₂O₃, ZrO₂, SiO₂, TiO₂, ZnO, BaTiO₃, SrTiO₃, CaCO₃, CaO, CeO₂, NiO, MgO, SNO₂, Y₂, O₃, Pb (ZrTi)O₃, and (Zr,ti)O₃. In another exemplary embodiment, ceramic may include BaTiO₃ and Al₂O₃ such as described in U.S. Patent Publication No. US 2025/0112243A1 to Kim et al., the disclosure of which is incorporated herein by reference in its entirety. Suitable exemplary polymers for the ceramic compound may include polyaniline, poly(vinyl acetate), polyvinyl alcohol, polyethylene oxide, polyisobutylene, (preferably high molecular weight polyisobutylene), butyl rubbers, polyvinyl pyrrolidone, alkylated polyethylene oxide, crosslinked polyethylene oxide, polyvinyl ether, poly(methyl methacrylate), polyvinylidene fluoride, poly(ethyl acrylate), polytetrafluoroethylene, polyvinyl chloride, polyacrylonitrile, polyvinylpyridine, polyvinylidene fluoride-co-hexafluoropropylene, polystyrene, and derivatives, blends and copolymers thereof, and the like, may be used.

The anode may be lithium metal, a lithium-containing alloy or any material that may intercalate/deintercalated lithium ions or materials which may reversibly form a chemical compound with the lithium. The anode may be lithium, a lithium composite, silicon, a silicon composite or a carbonaceous material. In another embodiment, the anode may be silicon or carbon based. For example, the silicon anode may be a porous silicon manufactured from formed silica such as described in U.S. Pat. No. 11,066,035 B2. Another example is nanostructured silicon with or without supplemental lithium may be used to form the anode such as described in U.S. Pat. No. 10,003,068 B2.

In yet another embodiment, the anode may be a silicon/carbon based anode such as described in U.S. Pat. No. 10,615,418 B1 or U.S. Publication No. 2024/0243269 A1. The silicon/carbon-based material may be a porous carbon infused silicon, porous carbon decorated silicon structure, porous silicon carbon hybrid, a porous silicon carbon alloy, a porous silicon carbon composite, silicon carbon alloy, silicon carbon composite, carbon decorated silicon structure, carbon infused silicon, carborundum, silicon carbide, and/or any suitable allotrope or mixture of silicon, carbon, and/or oxygen. For instance, the elemental composition of the silicon material can include SiOC, SiC, SiₓOₓC, SiₓOₓC_{y}, SiOₓC_{y}, SiₓC_{y}, SiOₓ, SiₓO_{y}, SiO₂C, SiO₂Cₓ, SiOCZ, SiCZ, SiₓO_{y}CZ, SiₓOₓCₓZₓ, SiₓCₓZ_{y}, SiOₓZₓ, SiₓOₓZ_{y}, SiO₂CZ, SiO_{z}CₓZ_{y}, and/or have any suitable composition (e.g., include additional element(s)), where Z can refer to any suitable element of the periodic table. It is noted that the silicon or silicon/carbon anode may be prelithiated using, for example, the printable composition provided herein. The anode may include a modulation layer as described above.

An anode-free battery (AFLMB) may also be provided. The anode-free battery may include a bare anode current collector, solid electrolyte, a hybrid electrolyte or a liquid electrolyte and the fully prelithiated sulfur or composite sulfur cathode wherein an anode is formed by extracting lithium ions from the prelithiated cathode during a first charge and deposited on the bare anode current collector. Exemplary current collectors may include copper, tin, nickel, stainless steel, carbon coated metal foils, metal coated polymer films, metal foil containing a sacrificial layer of lithium provided by the printable lithium formulation. Such anode-free batteries are described for example in U.S. Pat. No. 11,824,159 B2.

The following examples are merely illustrative of the invention and are not limiting thereof.

### EXAMPLES

### Control A

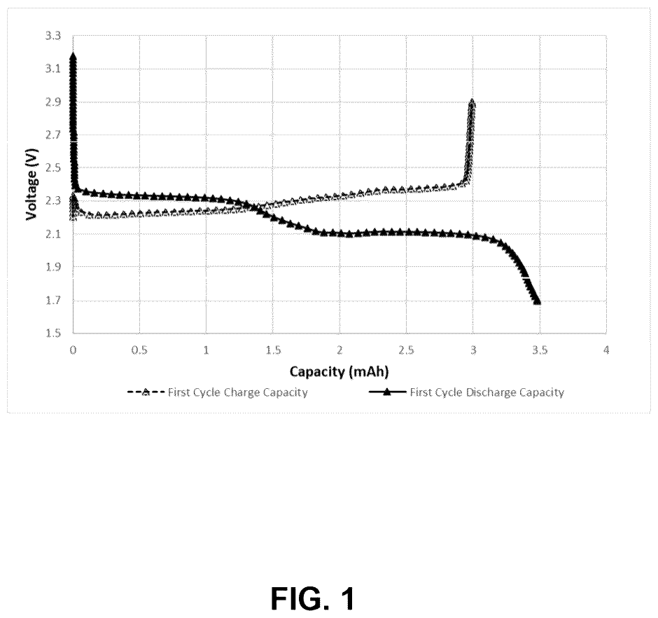

A coin cell was prepared having a 12.7 mm diameter Nanomyte sulfur cathode (70 percent sublimed and a loading of 3 mAh/cm²), 19 mm diameter Whatman fiberglass separator, 14 mm diameter 60 micron thick lithium disc anode and 1M LiTFSi/0.83M LiNO3 in DOL/DME electrolyte. The cathode size in the coin cell was 1.27 cm² so a 4 mAh capacity was expected in a first discharge. FIG. 1 shows that the stated capacity was unable to be achieved due to soluble polysulfide diffusion away from the cathode.

### Control B

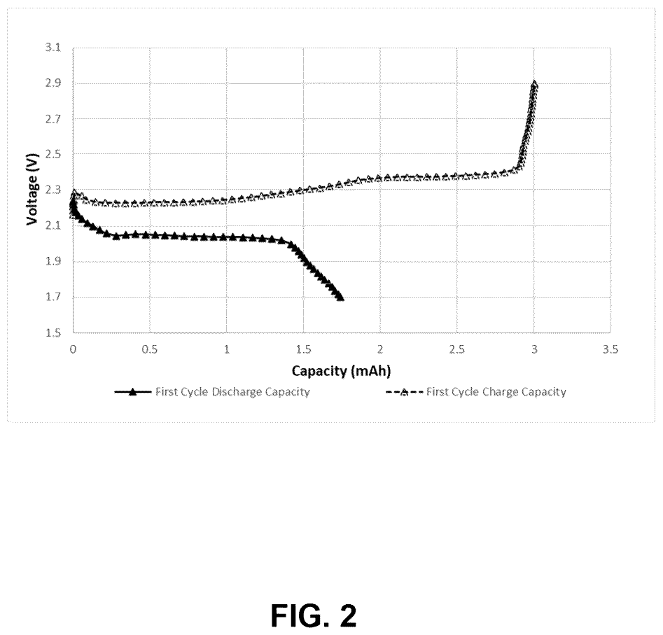

The coin cell of Control A having 2 mAh prelithiation of the cathode with a Liovix® printable lithium composition was prepared to demonstrate the effectiveness of a prelithiated cathode with no modulation layer. FIG. 2 shows that the prelithiation has been very effective. The capacity related to the first stage of lithiation has been almost eliminated due to the added lithium from the printable lithium composition. The prelithiation process will produce the long chain polysulfides the same as electrochemical prelithiation does. These cells were allowed to rest for 12 hr before the cycle testing started. This rest time allowed for the long chain polysulfides produced by prelithiation to diffuse away from the cathode. The result is a reduction in the second stage lithiation capacity even more dramatic than observed in the non-prelithiated baseline (Control A).

### Example 1

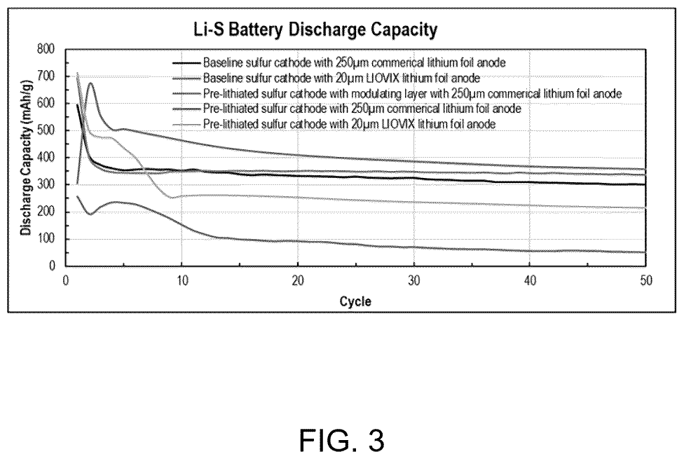

A modulation layer comprising 50 percent by weight SBR and two percent by weight carbon black is applied to a prefabricated sulfur cathode. The cathode is prelithiated with Liovix® printable lithium composition and comprises 80 percent sulfur, 10 percent polyvinylidene fluoride and 10 percent carbon black. A coin cell is formed comprising a 250 μm commercial foil layer, an electrolyte comprising 3M LiTFSi, 2 percent LiNO₃ and DOL/DME 1:1 volume, the prelithiated cathode, and the modulation layer. FIG. 3 is a plot showing cycling performance for a coin cell according to this example versus a 250 μm commercial lithium foil anode and a 20 μm printable lithium composition based anode with the same sulfur cathode and with a prelithiated cathode, and electrolyte of Control B. FIG. 3 demonstrates that application of a modulation layer can enhance the effectiveness of prelithiation of a sulfur cathode.

### Example 2

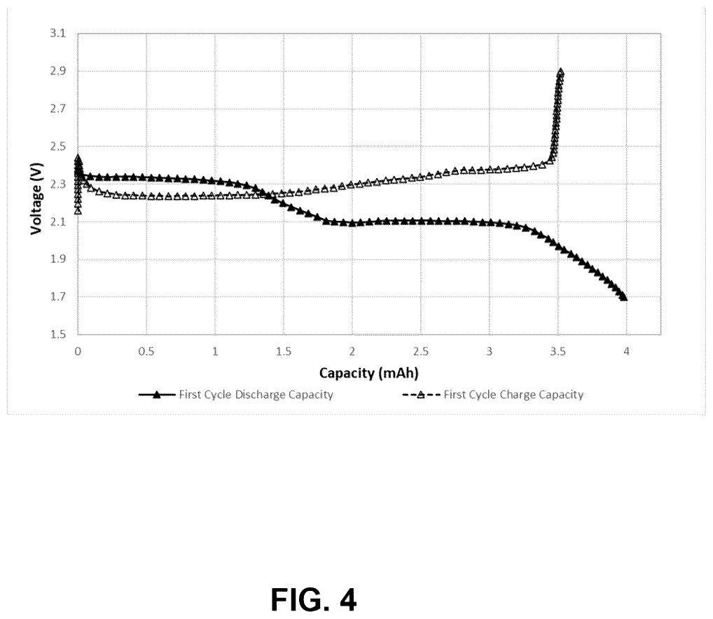

The coin cell of Control A with a 10 micron TiO₂/PVDF ceramic modulation layer on the non-prelithiated sulfur cathode with a layer of 2.0 mAh Liovix® printable lithium composition was tested. FIG. 4 shows when a ceramic modulating layer is coated on the sulfur cathode, the desired design capacity may be achieved. When the sulfur cathode is coated with a ceramic modulating layer, the long chain polysulfides are confined to the cathode and are available for further lithiation to short chain polysulfides and further to Li₂S.

### Example 3

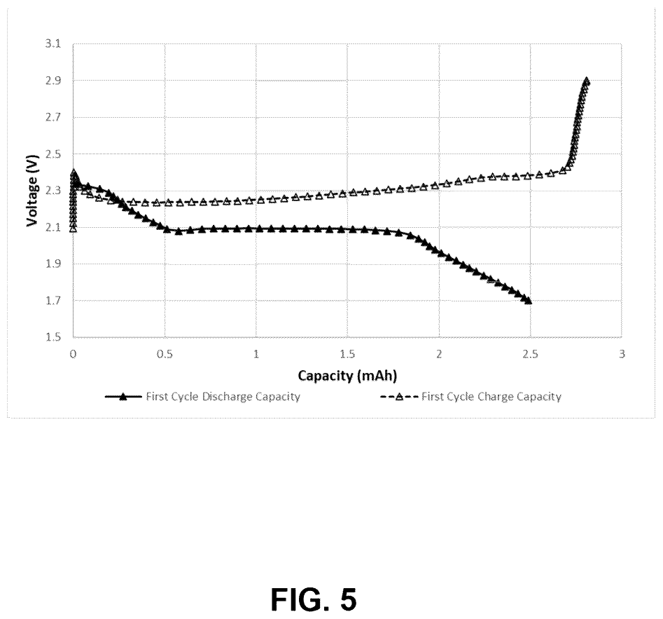

The coin cell of Example 2 having a Liovix® prelithiated sulfur cathode, a 10 micron TiO₂/PVDF ceramic modulation layer and a lithium metal anode was tested. FIG. 5 shows the prelithiation step was not as effective when using a modulation layer. This is likely due to the rate of lithium diffusion being slowed down. However, as seen in Example 2, the effectiveness of the layer to confine polysulfides to the cathode is evident. The capacity of the second stage lithiation for this cell type is 2.0 mAh which is 29 percent higher than when prelithiation was used without a modulation layer (Control B).

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

That which is claimed is:

1. A battery comprising:
a) an anode;
b) a cathode comprising a sulfur or composite sulfur material on a current collector or composite material, a prelithiation layer comprised of lithium metal powder, a polymer binder compatible with the lithium metal powder and a rheology modifier, and a modulation layer between the sulfur or composite material and the prelithiation layer wherein the polymeric coating modulation layer reduces the reaction of lithium and sulfur to avoid polysulfide shuttling and rapid diffusion of lithium; and
c) an electrolyte.

2. The battery according to claim 1, wherein the anode comprises a prelithiated silicon/carbon anode.

3. The battery according to claim 1, wherein the anode comprises a lithium foil or lithium film formed from a printable lithium composition comprised of lithium metal powder, a polymer binder compatible with the lithium metal powder, and a rheology modifier compatible with the lithium metal powder.

4. The battery according to claim 1, wherein the anode is prelithiated with a printable lithium composition comprised of lithium metal powder, a polymer binder compatible with the lithium metal powder, and a rheology modifier compatible with the lithium metal powder.

5. The battery according to claim 1, wherein the modulation layer is a polymeric coating on the sulfur or composite sulfur material cathode and the polymer is selected from the group consisting of polyaniline, poly(vinyl acetate), polyvinyl alcohol, polyethylene oxide, styrene-butadiene rubber, polyisobutylene, butyl rubbers, polyvinyl pyrrolidone, alkylated polyethylene oxide, crosslinked polyethylene oxide, polyvinyl ether, poly(methyl methacrylate), polyvinylidene fluoride, poly(ethyl acrylate), polytetrafluoroethylene, polyvinyl chloride, polyacrylonitrile, polyvinylpyridine, polyvinylidene fluoride-co-hexafluoropropylene, polystyrene, cross-linked quaternary ammonium cationic starch, polysaccharides, xanthan gum, and derivatives, blends and copolymers thereof.

6. The battery according to claim 5, wherein the polymeric coating modulation layer further includes a conductive additive.

7. The battery according to claim 6, wherein the conductive additive is selective from the group consisting of carbonaceous materials, electrolyte salts, LiF, metallic particles, solid electrolytes and polymer electrolytes.

8. The battery according to claim 1, wherein the modulation layer is a ceramic compound comprising a ceramic and a polymer.

9. The battery according to claim 8, wherein the ceramic is one or more of Al₂O₃, ZrO₂, SiO₂, TiO₂, ZnO, BaTiO₃, SrTiO₃, CaCO₃, CaO, CeO₂, NiO, MgO, SnO₂, Y₂O₃, Pb (ZrTi)O₃, and (ZrTi)O₃.

10. A solid-state battery comprising:
a) a lithium, lithium composite, silicon, silicon composite or carbonaceous materials anode;
b) an electrolyte layer; and
c) a cathode comprising a sulfur or composite material on a current collector or composite material, a prelithiation layer comprised of lithium metal powder, a polymer binder compatible with the lithium metal powder and a rheology modifier, and a modulation layer between the sulfur or composite material and the prelithiation layer wherein the modulation layer reduces the reaction of lithium and sulfur to avoid polysulfide shuttling and rapid diffusion of lithium.

11. The solid-state battery according to claim 10, wherein the anode comprises a prelithiated silicon/carbon anode.

12. The solid-state battery according to claim 10, wherein the anode comprises a lithium or lithium alloy foil or lithium foil formed from a printable lithium composition comprised of lithium metal powder, a polymer binder compatible with the lithium metal powder, and a rheology modifier compatible with the lithium metal powder.

13. The solid-state battery according to claim 10, wherein the anode is prelithiated with a printable lithium composition comprised of lithium metal powder, a polymer binder compatible with the lithium metal powder, and a rheology modifier compatible with the lithium metal powder.

14. The solid-state battery according to claim 10, wherein the modulation layer is a polymeric coating on the sulfur or composite sulfur material cathode and the polymer is selected from the group consisting of polyaniline, poly(vinyl acetate), polyvinyl alcohol, polyethylene oxide, styrene-butadiene rubber, polyisobutylene, butyl rubbers, polyvinyl pyrrolidone, alkylated polyethylene oxide, crosslinked polyethylene oxide, polyvinyl ether, poly(methyl methacrylate), polyvinylidene fluoride, poly(ethyl acrylate), polytetrafluoroethylene, polyvinyl chloride, polyacrylonitrile, polyvinylpyridine, polyvinylidene fluoride-co-hexafluoropropylene, polystyrene, cross-linked quaternary ammonium cationic starch, polysaccharides, xanthan gum, and derivatives, blends and copolymers thereof.

15. The solid-state battery according to claim 14, wherein the polymeric coating modulation layer further includes a conductive additive.

16. The battery according to claim 15, wherein the conductive additive is selective from the group consisting of carbonaceous materials, electrolyte salts, LiF, metallic particles, solid electrolytes and polymer electrolytes.

17. The battery according to claim 10, wherein the modulation layer comprises a ceramic and a polymer.

18. The battery according to claim 17, therein the one or more one or more of Al₂O₃, ZrO₂, SiO₂, TiO₂, ZnO, BaTiO₃, SrTiO₃, CaCO₃, CaO, CeO₂, NiO, MgO, SnO₂, Y₂O₃, Pb (ZrTi)O₃, and (ZrTi)O₃.

19. The battery according to claim 17, wherein the current collector of the cathode is selected from the group consisting of foamed aluminum, aluminum foil, foamed nickel, nickel foil, a carbon-based material and stainless steel foil.

20. An anode-free solid-state battery comprising:
a) an electrolyte;
b) a cathode comprising a sulfur or composite material on a current collector or composite material, a prelithiation layer comprised of lithium metal powder, a polymer binder compatible with the lithium metal powder and a rheology modifier, and a modulation layer between the sulfur or composite material and the prelithiation layer wherein the modulation layer reduces the reaction of lithium and sulfur to avoid polysulfide shuttling, and
c) wherein an anode is formed by extracting lithium ions from the prelithiated cathode during a first charge.

21. The anode-free solid state battery according to claim 20, wherein the modulation layer comprised a polymer coating or a ceramic and a polymer.

22. The anode-free solid-state battery of claim 20, wherein the electrolyte is a solid electrolyte, a semi-solid electrolyte or a hybrid electrolyte.
